(19) United States
(12) Patent Application Publication
(10) Pub. No.: US 2021/0081851 A1
(43) Pub. Date: Mar. 18, 2021

(54) RESERVATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Teppei AOKI, Kanagawa (JP); Nana AKIMOTO, Kanagawa (JP); Izumi NAKANO, Kanagawa (JP)

(73) Assignee: FUJI XEROX CO., LTD., Tokyo (JP)

(21) Appl. No.: 16/744,204

(22) Filed: Jan. 16, 2020

(30) Foreign Application Priority Data
Sep. 12, 2019 (JP) 2019-166569

(51) Int. Cl. G06Q 10/02; H04W 4/02; G06Q 50/12; H04W 4/30

(52) U.S. Cl. CPC G06Q 10/02; H04W 4/30; G06Q 50/12; H04W 4/027

(57) ABSTRACT

A reservation processing apparatus includes a moving body specification unit that specifies a moving body, a facility specification unit that specifies a facility to be visited using the moving body, a requesting unit that makes a request for a reservation for the facility, and a processing unit that performs processing of making a reservation for the moving body in a case where the request for the reservation for the facility is accepted.

### CROSS-REFERENCE TO RELATED APPLICATIONS

This application is based on and claims priority under 35 USC 119 from Japanese Patent Application No. 2019-166569 filed Sep. 12, 2019.

### BACKGROUND

### (i) Technical Field

The present invention relates to a reservation processing apparatus and a non-transitory computer readable medium storing a program.

### (ii) Related Art

A conference holding and schedule management support apparatus (for example, refer to JP1997-091341A (Alias: JP H9-091341A)) is known in which a conference holding agent, in a case where a desired conference holding condition is designated from a user who holds a conference, notifies a conference holding place to respective schedule management agents of all users who request attendance to a conference and inquiries about spare time in an area of a desired holding date and time, the schedule management agents of attendance requestors reply to the conference holding agent with pieces of spare time information, from which movement time to the holding place is subtracted, and the conference holding agent acquires the pieces of spare time information, determines a conference holding schedule based on the pieces of spare time information of all the attendance requestors, and posts up and checks the conference holding schedule to a conference host, and provides a conference holding notification to the schedule management agents of the attendance requestors.

### SUMMARY

In a case where a facility is visited using a moving body, there is a case where a reservation for the facility is made by making a request for the reservation for the facility. In this case, there is a problem in that the reservation for the moving body is made before the request for the reservation for the facility is accepted in a case where it is desired to make a reservation for the moving body together with the facility in the case.

In addition, there is a case where the reservation for the moving body is made by making a request for the reservation for the moving body in a case where the facility is visited using the moving body. Here, in a case where it is desired to make the reservation for the facility together with the moving body, there is a problem in that the reservation for the facility is made before the request for the reservation for the moving body is accepted.

Aspects of non-limiting embodiments of the present disclosure relate to a reservation processing apparatus and a non-transitory computer readable medium storing a program, which suppress the reservation for the moving body before the request for the reservation for the facility is accepted.

Aspects of non-limiting embodiments of the present disclosure relate to a reservation processing apparatus and a non-transitory computer readable medium storing program, which suppress the reservation for the facility before the request for the reservation for the moving body is accepted.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a reservation processing apparatus including: a moving body specification unit that specifies a moving body; a facility specification unit that specifies a facility to be visited using the moving body; a requesting unit that makes a request for a reservation for the facility; and a processing unit that performs processing of making a reservation for the moving body in a case where the request for the reservation for the facility is accepted.

### BRIEF DESCRIPTION OF THE DRAWINGS

Exemplary embodiment(s) of the present invention will be described in detail based on the following figures, wherein:

FIG. 1 is a diagram illustrating an example of a whole configuration of a reservation system to which an exemplary embodiment of the present invention is applied;

FIG. 2 is a diagram illustrating an example of a hardware configuration of a reservation server according to the exemplary embodiment of the present invention;

FIGS. 3A and 3B are diagrams illustrating examples of reservation request screens displayed on a mobile terminal in the reservation system according to the exemplary embodiment of the present invention;

FIG. 4 is a diagram illustrating an example of a schedule screen displayed on the mobile terminal in a case where a prior work is performed before a destination place is visited;

FIG. 5 is a diagram illustrating an example of a detailed schedule setting screen which is started from the schedule screen and is displayed on the mobile terminal;

FIG. 6 is a diagram illustrating an example of the schedule screen after detailed information is set in the detailed schedule setting screen;

FIG. 7 is a diagram illustrating an example of a facility selection screen which is started from the schedule screen and is displayed on the mobile terminal;

FIG. 8 is a diagram illustrating an example of a map screen which is started from the facility selection screen and is displayed on the mobile terminal;

FIG. 9 is a diagram illustrating an example of the schedule screen in a case where a facility is selected in the facility selection screen;

FIG. 10 is a diagram illustrating an example of a reservation management screen displayed on a side of a facility server in the reservation system according to the exemplary embodiment of the present invention;

FIG. 11 is a block diagram illustrating an example of a functional configuration of the reservation server according to the exemplary embodiment of the present invention;

FIG. 12 is a diagram illustrating a detailed example of moving body information stored in a moving body information storage unit of the reservation server according to the exemplary embodiment of the present invention;

FIG. 13 is a diagram illustrating a detailed example of facility information stored in a facility information storage unit of the reservation server according to the exemplary embodiment of the present invention;

FIG. 14 is a flowchart illustrating an operational example of the reservation server according to the exemplary embodiment of the present invention;

FIG. 15 is a flowchart illustrating an operational example of step S202 in a case where the prior work is performed before the destination place is visited; and

FIG. 16 is a flowchart illustrating an operational example of step S203 in the case where the prior work is performed before the destination place is visited.

### DETAILED DESCRIPTION

Hereinafter, an exemplary embodiment of the present invention will be described in detail with reference to the accompanying drawings.

Overall Configuration of Reservation System

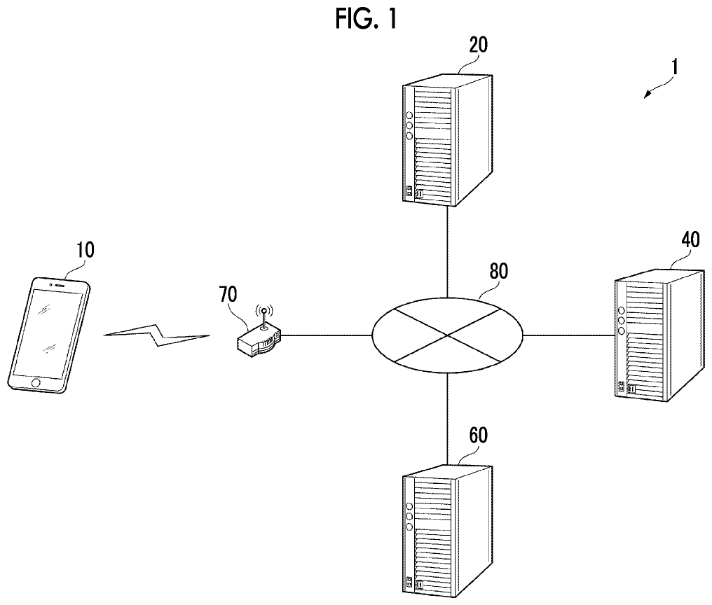

FIG. 1 is a diagram illustrating an example of a whole configuration of a reservation system 1 to which an exemplary embodiment is applied. As illustrated in the drawing, the reservation system 1 includes a mobile terminal 10, a reservation server 20, a moving body server 40, and a facility server 60. The mobile terminal 10 is capable of wirelessly connecting to a communication line 80 through an access point by wireless communication such as Wi-Fi (registered trademark). In addition, the reservation server 20, the moving body server 40, and the facility server 60 are connected to the communication line 80. The communication line 80 may be, for example, the Internet.

The mobile terminal 10 is a terminal device which is used for a user of the reservation system 1 to make reservations for a moving body and a facility. In the drawing, although only one mobile terminal 10 is illustrated, a plurality of mobile terminals may exist. It is assumed that a general-purposed browser is installed in the mobile terminal 10, and the browser displays a screen transmitted from the reservation server 20. The mobile terminal 10 may be realized by, for example, a smart phone.

The reservation server 20 is a server computer which makes a moving body reservation request to the moving body server 40 and a facility reservation request to the facility server 60 in a lump, and transmits reservation completion notifications of the moving body and the facility to the mobile terminal 10. Specifically, in a case where the facility reservation request to the facility server 60 is made, the reservation server 20 inquires of the facility server 60 about a reservation situation first. Further, for example, in a case where the reservation completion notification is received from the facility server 60 in such a way that staff of the facility determines that the reservation is possible and performs a reservation operation, the reservation completion notification is transmitted to the mobile terminal 10, and, accordingly, the reservation for the facility may be confirmed. Although only one reservation server 20 is illustrated in the drawing, a plurality of reservation servers 20 may exist. In the present exemplary embodiment, the reservation server 20 is provided as an example of a reservation processing apparatus.

The moving body server 40 is a server computer which makes a reservation for the moving body. Although only one moving body server 40 is illustrated in the drawing, a plurality of moving body servers 40 may exist. In this case, the moving body servers 40 may exist, for example, for respective types of moving bodies. Here, the moving bodies refer to movement means used in a case where a user moves, and include, for example, ridesharing in addition to traffic facilities, such as a train, a bus, a taxi, an airplane, and a ship. In addition, the types of the moving bodies are types corresponding to companies which operate the moving bodies. For example, in a case where the moving bodies are trains and railroad companies which operate the trains are different from each other, the types of the moving bodies are different from each other. Also, normally, sites, on which reservations for the moving bodies are made, exist for respective companies which operate the moving bodies. Therefore, in a case where the types of the moving bodies are different from each other, the sites, on which the reservations for the moving bodies are made, are different from each other.

The facility server 60 is a server computer which makes the reservation for the facility. Although only one facility server 60 is illustrated in the drawing, a plurality of facility servers 60 may exist. In this case, the facility servers 60 may exist, for example, for respective types of facilities. Here, the facilities refer to spaces where the user temporarily stays, and includes, for example, a work booth, a conference room, a cafe, a restaurant, a hotel, and the like. In a case where the facilities are the work booth, the conference room, the cafe, and the restaurant, it is assumed to do a work, such as business, during stay. In a case where the facilities are the cafe and the restaurant, it is assumed to have a meal during the stay. In a case where the facility is the hotel, it is assumed to take a rest or stay during the stay. However, a concept of the facility is not limited by a behavior performed during the stay. In addition, the types of the facilities are types corresponding to companies which manage the facilities. For example, in a case where it is assumed that the facilities are the cafes and types of companies which manage the cafes are different from each other, the types of the facilities are different from each other. Also, normally, sites, on which the reservations for the facilities are made, exist for the respective companies which operate the facilities. Therefore, in a case where the types of the facilities are different from each other, the sites, on which the reservations for the facilities are made, are different from each other.

Hardware Configuration of Reservation Server

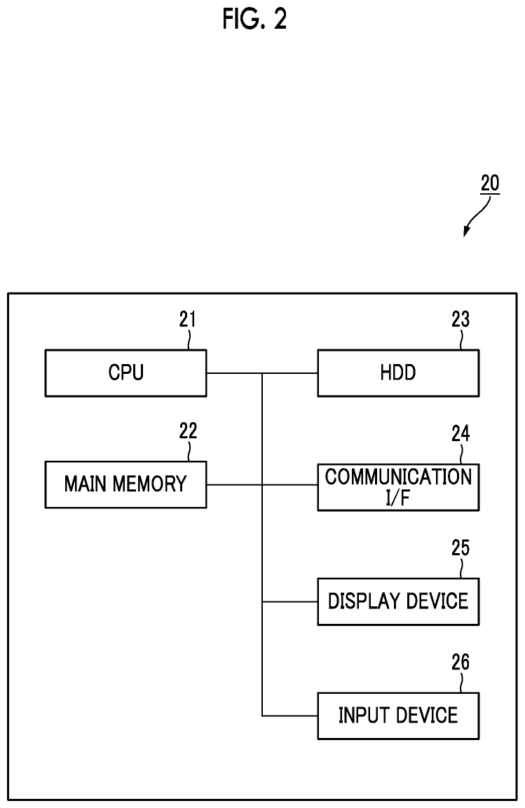

FIG. 2 is a diagram illustrating an example of a hardware configuration of the reservation server 20 according to the present exemplary embodiment. As illustrated in the drawing, the reservation server 20 includes a CPU 21 which is arithmetic means, and a main memory 22 and a Hard Disk Drive (HDD) 23, which are storage means. Here, the CPU 21 executes an Operating System (OS) and various types of software, such as applications, and realizes respective functions which will be described later. In addition, the main memory 22 is a storage area which stores the various types of software, data used for execution of the software, and the like. The HDD 23 is a storage area which stores input data with respect to the various types of software, output data from the various types of software, and the like. Further, the reservation server 20 includes a communication I/F 24 for performing communication with the outside, a display device 25, such as a display, and an input device 26 such as a keyboard or a mouse.

Outline of Present Exemplary Embodiment

In the present exemplary embodiment, in a case where the reservation server 20 makes a request for the reservation for the facility with respect to the facility server 60 and the request for the reservation for the facility is accepted by the facility server 60, processing of making the reservation for the moving body with respect to the moving body server 40 is performed in the reservation system 1. Otherwise, in a case where the moving body is replaced with the facility, the reservation server 20 makes a request for the reservation for the moving body with respect to the moving body server 40, and the request for the reservation for the moving body is accepted by the moving body server 40, processing of making a reservation for the facility with respect to the facility server 60 is performed. Hereinafter, in the former case, that is, a case where the processing of making the reservation for the moving body is performed in a case where the request for the reservation for the facility is accepted will be described as an example.

Also, in the above, “the request for the reservation is accepted” may indicate that the reservation is completed, or may indicate that a reply is performed in which, although the reservation is not completed at a point of time, reservation processing will be performed later. Hereinafter, description will be performed while assuming that “the request for the reservation is accepted” indicates that the reservation is completed.

### DETAILED EXAMPLE OF EXEMPLARY EMBODIMENT

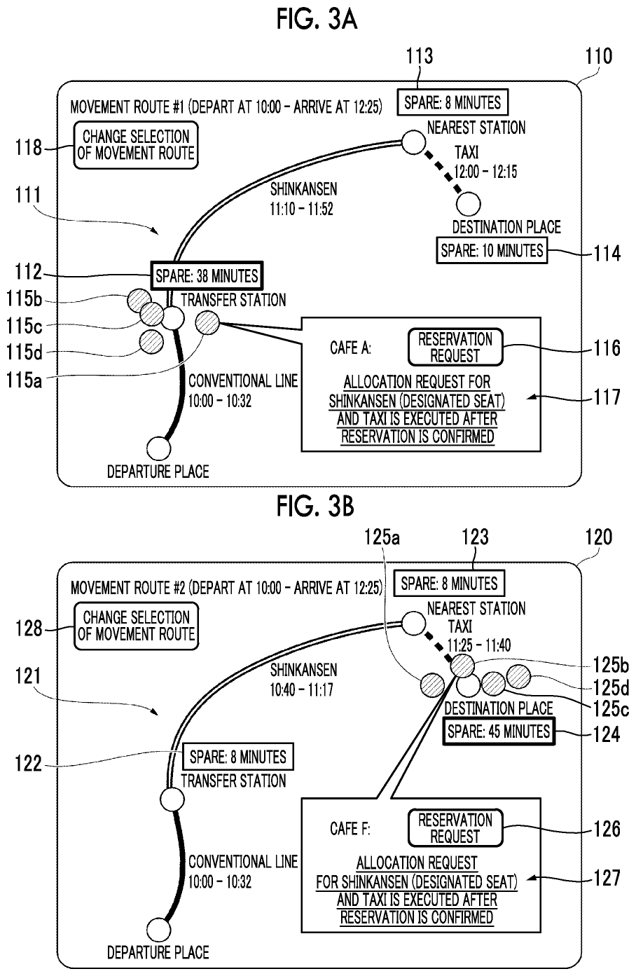

FIGS. 3A and 3B are diagrams illustrating examples of reservation request screens displayed on the mobile terminal in the reservation system 1 according to the present exemplary embodiment.

Here, in a reservation request screen 110 of FIG. 3A is displayed with a display element 111 which shows a first movement route in a case where a departure place is departed at 10:00 and a destination place is arrived at 12:25. Specifically, it is shown that movement is performed through a conventional line from the departure place to the transfer station and the conventional line shows that the departure place is departed at 10:00 and a transfer station is arrived at 10:32. It is shown that the movement is performed by Shinkansen from the transfer station to the nearest station of the destination place (hereinafter, simply referred to as “nearest station”) and the Shinkansen departs from the transfer station at 11:10 and arrives at the nearest station at 11:52. It is shown that the movement is performed by a taxi from the nearest station to the destination place and the taxi departs from the nearest station at 12:00 and arrives at the destination place at 12:15.

In addition, the reservation request screen 110 of FIG. 3A is displayed with a display element 112 which shows that spare time at the transfer station is 38 minutes, a display element 113 which shows that spare time at the nearest station is 8 minutes, and a display element 114 which shows that spare time immediately before the destination place is 10 minutes. In the first movement route, it is assumed that the spare time at the transfer station is equal to or longer than a predetermined time, and thus the display element 112 is emphasized and displayed to be shown by being surrounded by a thick line. Further, display elements 115a to 115d, which show a plurality of facilities in the vicinity of the transfer station, are displayed. In this state, in a case where the user selects the display element 115a which shows a cafe A, a button 116 for making a request for a reservation for the cafe A and a message 117, which shows that requests for reservations for the Shinkansen and the taxi are made after the reservation is confirmed, are displayed.

Further, a button 118 for changing selection of the first movement route is also displayed in the reservation request screen 110 of FIG. 3A.

In contrast, a reservation request screen 120 of FIG. 3B is displayed with a display element 121 which shows a second movement route in the case where the departure place is departed at 10:00 and the destination place is arrived at 12:25. Specifically, it is shown that the movement is performed through the conventional line from the departure place to the transfer station and the conventional line shows that the departure place is departed at 10:00 and the transfer station is arrived at 10:32. It is shown that the movement is performed by the Shinkansen from the transfer station to the nearest station and the Shinkansen departs from the transfer station at 10:40 and arrives at the nearest station at 11:17. It is shown that the movement is performed by the taxi from the nearest station to the destination place and the taxi departs from the nearest station at 11:25 and arrives at the destination place at 11:40.

In addition, the reservation request screen 120 of FIG. 3B is displayed with a display element 122 which shows that the spare time at the transfer station is 8 minutes, a display element 123 which shows that the spare time at the nearest station is 8 minutes, and a display element 124 which shows that the spare time immediately before the destination place is 45 minutes. In the second movement route, it is assumed that the spare time immediately before the destination place is equal to or longer than the predetermined time, and thus the display element 124 is emphasized and displayed to be shown by being surrounded by a thick line. Further, display elements 125a to 125d, which show a plurality of facilities in the vicinity of the destination place, are displayed. In this state, in a case where the user selects the display element 125b which shows a cafe F, a button 126 for making a request for a reservation for the cafe F and a message 127, which shows that the requests for reservations for the Shinkansen and the taxi are made after the reservation is confirmed, are displayed.

Further, a button 128 for changing selection of the second movement route is also displayed in the reservation request screen 120 of FIG. 3B.

However, in the reservation request screens of FIGS. 3A and 3B, it is assumed that the moving body is specified by designating the departure place, the destination place, and a destination place arrival time. However, it is considered that the moving body is specified such that work time is secured by designating the work time in a case where it is necessary to perform a work before or after the visit to the destination place. Here, as the work before the visit, a work of confirming a presentation material in a case where presentation is performed through the visit is exemplified. In addition, as the work after the visit, a work of preparing a conference report in a case where the conference is performed through the visit is exemplified. Hereinafter, a detailed example of a case where the work is performed before the visit to the destination place will be described among the works.

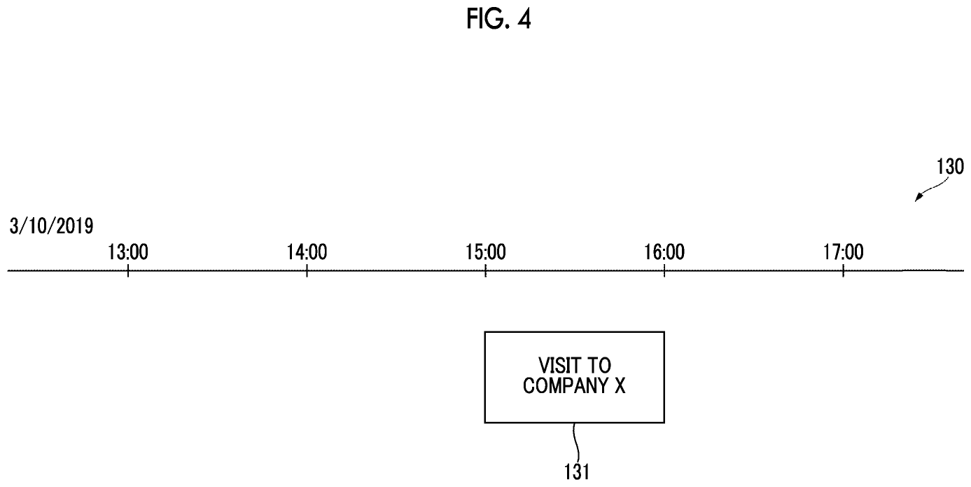

FIG. 4 is a diagram illustrating an example of a schedule screen 130 displayed on the mobile terminal 10.

In a case where the user designates the destination place and a visiting day and a visiting time of the destination place, a gist of the visit to the destination place is set as a conduct item at a place corresponding to the visiting time on the schedule screen 130 on the visiting day. In the drawing, it is assumed that a company X is designated as the destination place, 10, Mar., 2019 is designated as the visiting day, time from 15:00 to 16:00 is designated as the visiting time, respectively, and the display element 131, which shows a conduct item “visit to X company” is displayed at a place corresponding to the time from 15:00 to 16:00 on the schedule screen 130 of 10, Mar., 2019. In a case where the user clicks the display element 131 in this state, the detailed schedule setting screen for setting the detailed information of schedule is started.

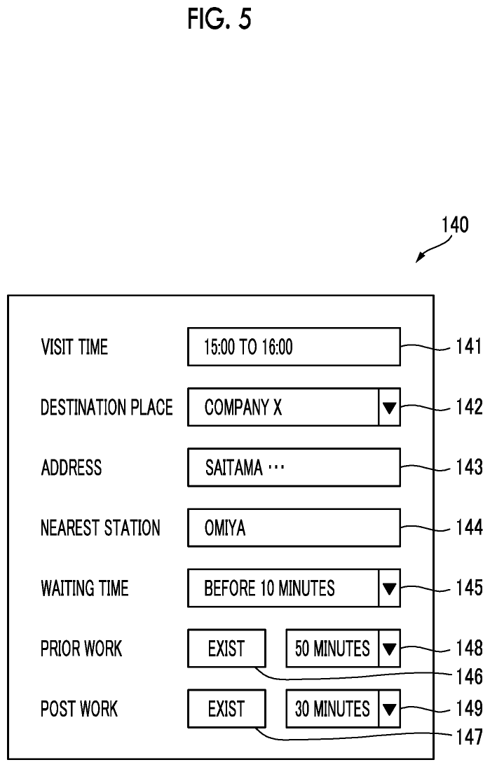

FIG. 5 is a diagram illustrating an example of a detailed schedule setting screen 140 which is displayed on the mobile terminal 10.

In the detailed schedule setting screen 140, the visiting time and the destination place, which are set on the schedule screen 130 of FIG. 4, are respectively displayed in a visiting time field 141 and a destination place field 142.

In addition, in the detailed schedule setting screen 140, an address of the destination place, the nearest station of the destination place, and waiting time, which shows a desired minute before the visiting time to be arrived to the destination place, are respectively input to an address field 143, a nearest station field 144, and a waiting time field 145.

Further, in the detailed schedule setting screen 140, existence/non-existence of a work before the visit to the destination place (hereinafter, referred to as a “prior work”) and existence/non-existence of a work after the visit to the destination place (hereinafter, referred to as a “post work”) are respectively input to a prior work existence/non-existence field 146 and a post work existence/non-existence field 147. Further, in a case where “exist” is input to the prior work existence/non-existence field 146, target time (hereinafter, referred to as “target prior work time”), in which the prior work is performed, is input to the target prior work time field 148. In a case where “exist” is input to the post work existence/non-existence field 147, target time (hereinafter, referred to as “target post work time”), in which the post work is performed, is input to the target post work time field 149. In addition, although not illustrated in FIG. 5, security levels may be set with respect to the prior work and the post work. As a work of a high security level, a work of confirmation of a contract is exemplified.

Also, in a case where the destination place is selected after the detailed information is input once, another piece of detailed information may be displayed as a default value.

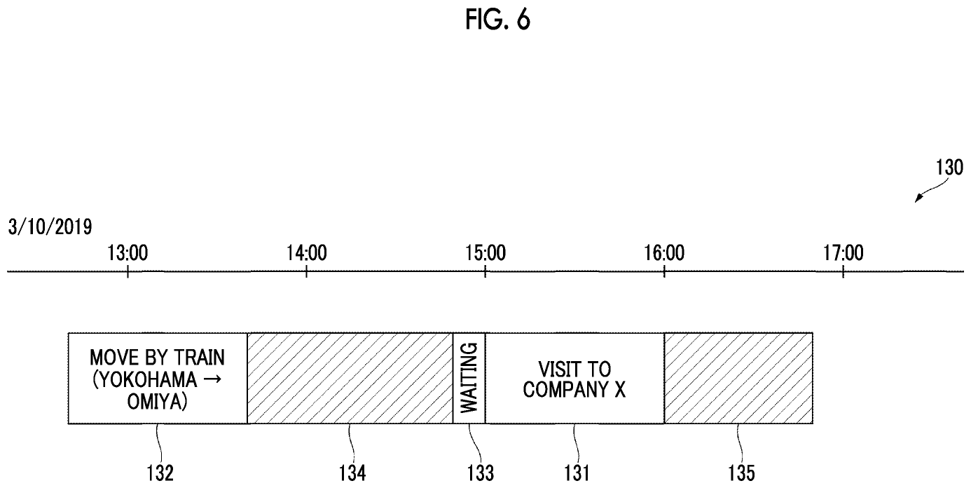

FIG. 6 is a diagram illustrating an example of the schedule screen 130 after the detailed information is set in the detailed schedule setting screen 140 of FIG. 5.

In a case where the address of the destination place, the nearest station of the destination place, the waiting time, and the like are set in the detailed schedule setting screen 140 of FIG. 5, the moving body, which is used in a case where the movement is performed from a company that is set as a default to the destination place, and a movement time are calculated. Here, free time is used as the destination place arrival time by performing subtraction from a start point of the visiting time. Further, a gist, in which a specific moving body is used as the conduct item at a place corresponding to the movement time on the schedule screen 130 of FIG. 4, is added, and the schedule screen 130 illustrated in FIG. 6 is acquired. In the drawing, a train, which departs from a Yokohama station at 12:40 and arrives at Omiya station at 13:40, is specified as the moving body, and the display element 132 which shows a conduct item “move by train (Yokohama Omiya)” is displayed at a place corresponding to 12:40 to 13:40 on the schedule screen 130.

However, here, in a case where the prior work existence/non-existence field 146 is “exist”, the spare time between a nearest station arrival time and destination place arrival time is provisionally set to a sum of the target prior work time and provisional movement time. Here, the provisional movement time may be, for example, a walk time of 20 minutes. However, in a case where total time of first movement time for movement from the nearest station to the facility, the target prior work time, and second movement time for movement from the facility to the destination place is shorter than provisionally set time, the total time on a shorter side may be used as the spare time. In the drawing, the waiting time from the destination place arrival time to the visiting time is shown by a display element 133 which shows a conduct item “waiting”. In addition, the spare time from the nearest station arrival time to the destination place arrival time is shown by a hatched display element 134. Here, in a case where the display element 133 is clicked, a facility selection screen for selecting a facility in which the prior work is performed in the spare time is started.

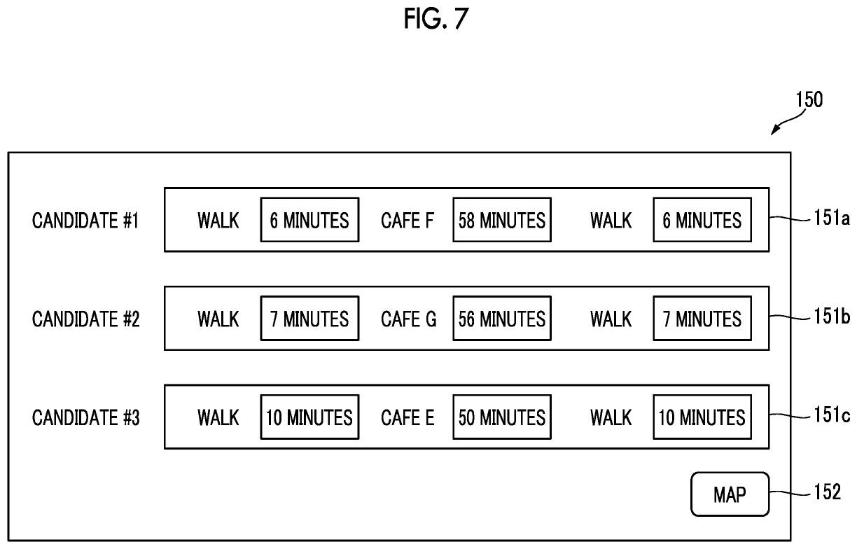

FIG. 7 is a diagram illustrating an example of a facility selection screen 150 which is displayed on the mobile terminal 10 in this case.

As illustrated in the drawing, the facility selection screen 150 is displayed with a row 151a which shows a first candidate of the facility, a row 151b which shows a second candidate of the facility, and a row 151c which shows a third candidate of the facility. Here, the rows 151a to 151c respectively include the first movement time from the nearest station to the facility, a name of the facility, the prior work time in the facility, and the second movement time from the facility to the destination place.

Since the target prior work time is set to 50 minutes in the detailed schedule setting screen 140 of FIG. 5, the target prior work time is also set to 50 minutes in FIG. 7, and a provisional movement time of 20 minutes is added to the target prior work time, and thus the spare time becomes 70 minutes. Further, since the first candidate is the cafe F and both the first movement time from the nearest station to the cafe F and the second movement time from the cafe F to the destination place are 6 minutes, the row 151a shows that the prior work time in the cafe F is 58 minutes. Since the second candidate is the cafe G and both the first movement time from the nearest station to the cafe G and the second movement time from the cafe G to the destination place are 7 minutes, the row 151b shows that the prior work time in the cafe G is 56 minutes. Since the third candidate is the cafe E and both the first movement time from the nearest station to the cafe E and the second movement time from the cafe E to the destination place are 10 minutes, the row 151c shows that the prior work time in the cafe E is 50 minutes. Also, it is possible to make reservations for all the cafes E, F, and G in time between a time acquired by adding the first movement time to the nearest station arrival time and a time acquired by subtracting the second movement time from the destination place arrival time.

In addition, here, although the candidates of the facility are displayed by being arranged in order that the prior work time is long, the candidates of the facility may be displayed by being arranged in order that the prior work time is close to the target prior work time.

Further, in a case where the high security level is set to the prior work in the detailed schedule setting screen 140 of FIG. 5, display content may be changed by collating the high security level of the prior work with the security level of the facility. For example, only facilities whose security levels are equal to or higher than predetermined reference may be displayed as the candidates. Otherwise, the security level of the facility may be displayed on each row which shows the candidate of the facility. In this case, the candidate of the facility may be displayed by being arranged in order that the security level of the facility is high.

In addition, in the facility selection screen 150, a map button 152 is also displayed. In a case where the map button 152 is clicked, a map screen, which includes a map in the vicinity of the nearest station, is started.

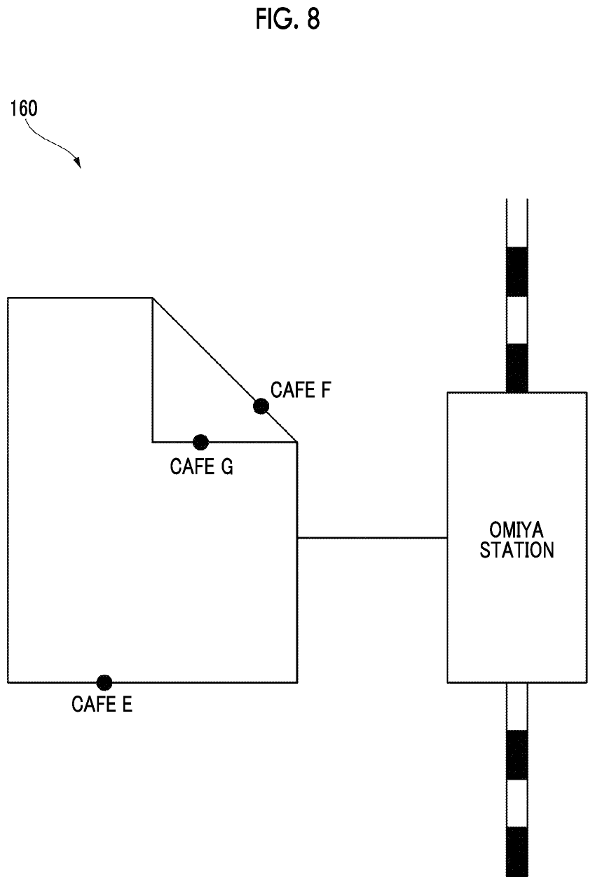

FIG. 8 is a diagram illustrating an example of a map screen 160 which is displayed on the mobile terminal 10 in this case.

Here, since Omiya station is exemplified as the nearest station, a map of a vicinity of the Omiya station is illustrated as the map in the vicinity of the nearest station. In the map, the places of the cafes E, F, and G are illustrated. That is, the map is illustrated so as to intuitively understand that time is the shortest in a case where the movement is performed from the nearest station to the cafe F and then the movement is performed from the cafe F to the destination place, time is the next shortest in a case where the movement is performed from the nearest station to the cafe G and then the movement is performed from the cafe G to the destination place, and time is the longest in a case where the movement is performed from the nearest station to the cafe E and then the movement is performed from the cafe E to the destination place.

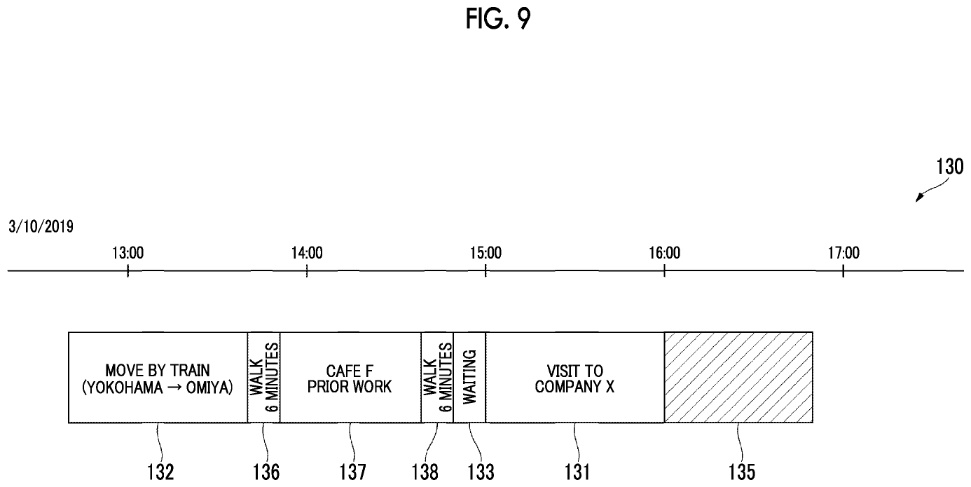

FIG. 9 is a diagram illustrating an example of the schedule screen 130 in a case where the facility is selected in the facility selection screen 150 of FIG. 7.

It is assumed that the user selects one candidate among the candidates of the facility on the facility selection screen 150 of FIG. 7. In this case, information is added to the display element 133, which shows the spare time, on the schedule screen 130 of FIG. 6, the schedule screen 130 illustrated in FIG. 9 is acquired. In the drawing, a case is assumed where the user clicks the row 151a on the facility selection screen 150 of FIG. 7, and a display element 136 which shows a conduct item “6 minutes by walk”, a display element 137 which shows a conduct item “prior work in cafe F”, and a display element 138 which shows a conduct item “6 minutes by walk” are displayed.

Also, although a detailed example of a case of specifying the moving body which arrives at the nearest station in order to secure the target prior work time is illustrated in the above, the detailed example is applied to a case of specifying the moving body which departs from the nearest station in order to secure the target post work time. In this case, for example, a display element which shows a conduct item “move by train” is added subsequent to the hatched display element 135 of FIG. 6, and display elements which show conduct items “walk” and “post work” are added in the hatched display element 135 of FIG. 6.

However, in FIG. 7, although description is performed such that it is possible to make the reservations for all the cafes E, F, and G in time between the time acquired be adding the first movement time to the nearest station arrival time and the time acquired by subtracting the second movement time from the destination place arrival time, a reservation management screen for performing management of the reservation on a side of the facility will be also described.

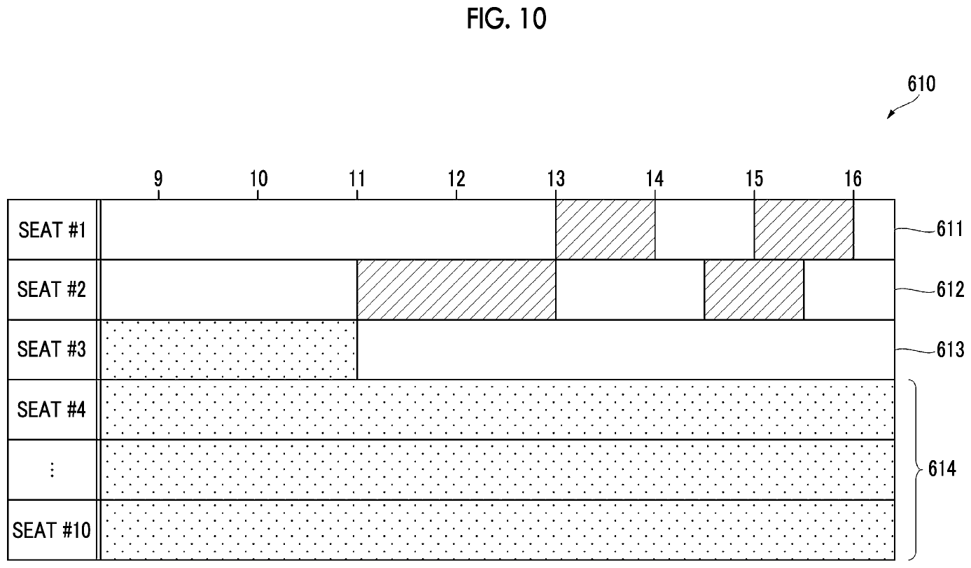

FIG. 10 is a diagram illustrating an example of a reservation management screen 610 which is displayed on a side of the facility server 60. As the reservation management screen 610, a screen for managing 10 seats in a cafe will be described as an example.

Here, seats #1 and #2 which are respectively shown in rows 611 and 612 are seats which are secured as seats for work. Also, hatching in times 13:00 to 14:00 and 15:00 to 16:00 in the row 611 shows that a reservation for the seat #1 is made in the times. In addition, hatching in times 11:00 to 13:00 and 14:30 to 15:30 in the row 612 shows that a reservation for the seat #2 is made in the times.

In addition, a seat #3 shown in a row 613 is a seat which is secured as a normal seat for a meal as shown using half-tone dot meshing until 11:00, and which is secured as a seat for work after 11:00. Also, since the row 613 is not hatched, a reservation for the seat #3 is not made after 11:00.

Further, seats #4 to #10 shown in a row 614 are seats which are secured as normal seats for meals, all day, as shown using half-tone dot meshing.

In a case where a facility reservation request is provided from the reservation server 20 to the facility server 60, a clerk of a cafe makes a reservation for a seat in a case where there is a seat which is available to be reserved in a designated time while referring to a reservation situation on the reservation management screen 610. Therefore, the facility server 60 transmits the reservation completion notification to the reservation server 20.

Also, here, the seats #1 and #2 are set as seats for work all day, the seat #3 is switched from the seat for work to the normal seat for the meal during a day, and the seats #4 to #10 are set as the seats for the meals all day. However, allocation of the seats may not be fixed. The clerk of the cafe may flexibly change the allocation of the seats for work and the normal seats for the meals according to a situation of the day.

Functional Configuration of Reservation Server

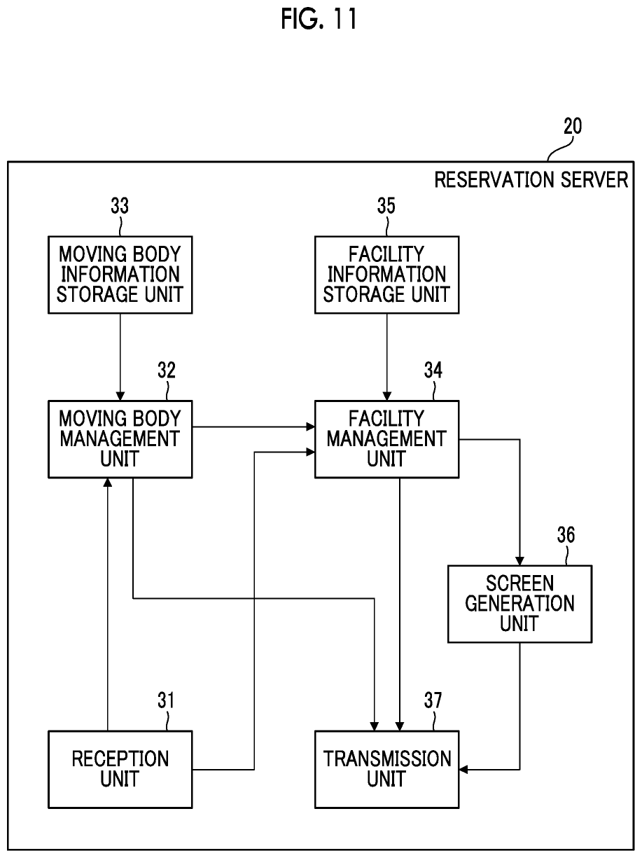

FIG. 11 is a block diagram illustrating an example of a functional configuration of the reservation server 20 according to the present exemplary embodiment. As illustrated in the drawing, the reservation server 20 according to the present exemplary embodiment includes a reception unit 31, a moving body management unit 32, a moving body information storage unit 33, a facility management unit 34, a facility information storage unit 35, a screen generation unit 36, and a transmission unit 37.

The reception unit 31 receives pieces of information of the departure place, the destination place, and the destination place arrival time from the mobile terminal 10. Here, as the destination place arrival time, a time which is acquired by subtracting waiting time from the start point of the visiting time that is set in the detailed schedule setting screen 140 of FIG. 5, may be received. Otherwise, in addition thereto, pieces of information, such as the nearest station, the target prior work time, and the target post work time, may be received from the mobile terminal 10.

In addition, in a case where a plurality of candidates of a facility is displayed on the mobile terminal 10, the reception unit 31 receives facility selection information, which shows a facility selected from the plurality of candidates, from the mobile terminal 10.

Further, the reception unit 31 receives a facility reservation completion notification of a gist that the reservation for the facility is completed from the facility server 60.

In a case where the reception unit 31 receives the pieces of information of the departure place, the destination place, and the destination place arrival time, from the mobile terminal 10, the moving body management unit 32 specifies the moving body to be used for the movement from the departure place to the destination place based on the pieces of information. Specifically, in addition to the type of the moving body, a moving body, which departs from the departure place at a certain time and arrives at the destination place at another certain time, is specified among the moving bodies of the type. In addition, a moving body, which moves from the departure place to the destination place through a certain place, is specified. Accordingly, specification of the moving body is specification of the movement route. In the present exemplary embodiment, the moving body management unit 32 is provided as an example of a moving body specification unit which specifies a moving body to be used. Also, the movement described here includes not only the movement by usage of the moving body but also movement by walk. In that sense, the usage of the moving body or the walk are examples of a plurality of movement methods including the usage of the moving body.

In addition, the moving body management unit 32 may acquire the moving body used up to the nearest station, the movement route, and an actual nearest station arrival time in a case where the moving body and the movement route are used by setting the time, which is acquired by subtracting the provisional spare time from the destination place arrival time, to a provisional nearest station arrival time and by using a path search Application Programming Interface (API). Therefore, the moving body, the movement route, and the nearest station arrival time are set in the schedule screen 130 of the mobile terminal 10, as illustrated in FIG. 6.

Here, for example, the provisional spare time, such as one hour, may be previously set by the user.

Otherwise, the provisional spare time may include the target prior work time designated by the user. In this case, the moving body management unit 32 calculates the provisional spare time by first adding the provisional movement time to the target prior work time received by the reception unit 31. Subsequently, the moving body management unit 32 calculates the provisional nearest station arrival time by subtracting the provisional spare time from the destination place arrival time received by the reception unit 31. Subsequently, the moving body management unit 32 specifies a moving body, which arrives at the nearest station at a time that is nearest to the provisional nearest station arrival time, among the moving bodies which move from the departure place to the nearest station, and which are received by the reception unit 31.

Here, the provisional movement time is time which is provisionally set as a sum of the movement time from the nearest station to the facility and the movement time from the facility to the destination place. For example, in a case where both the movement time from the nearest station to the facility and the movement time from the facility to the destination place are set to 10 minutes by walk, the provisional movement time may be 20 minutes by walk. Otherwise, in a case where the nearest station, the destination place, and locational information of the facility are input using an API of a map application, more accurate movement time from the nearest station to the facility and more accurate movement time from the facility to the destination place may be acquired.

In addition, here, although the provisional spare time includes the target prior work time, the provisional spare time may include time for stay in order to perform any behavior. In that sense, the target prior work time is an example of predetermined stay time, and the moving body management unit 32 is an example of the moving body specification unit which specifies a moving body that secures the predetermined stay time in any of the facilities.

In addition, in a case where the reception unit 31 receives the facility reservation completion notification from the facility server 60, the moving body management unit 32 acquires address information of the moving body server 30, which makes a reservation for the moving body of a type that is available to be reserved among previously specified moving bodies, from the moving body information storage unit 33. Further, the moving body management unit 32 reports the address information to the transmission unit 37, and instructs to transmit the moving body reservation request to the moving body server 40.

For each type of the moving body, the moving body information storage unit 33 stores moving body information including information, which shows whether or not a moving body of a certain type is available to be reserved, and address information of the moving body server 40 accessed in a case where the moving body of the type is reserved. The moving body information will be described in detail later.

In a case where the moving body management unit 32 specifies the moving body, the facility management unit 34 specifies a plurality of facilities visited during movement using the moving body. Specifically, the moving body management unit 32 specifies a plurality of facilities in a geographical range or in a time range, which is predetermined from the spot in the movement route specified by the moving body management unit 32. Here, as the spot in the movement route, for example, the departure place, the nearest station, or the destination place may be used. Otherwise, in a case where there is a transfer station for transferring from a type of a certain moving body to a type of another moving body, the transfer station may be used. In this case, the transfer station is an example of a transition spot between two movement methods. In addition, for example, a distance may be used as the predetermined geographical range, and, for example, movement time may be used as the predetermined time range. In generalization, it is possible to understand the predetermined geographical range and the predetermined time range as an area which specifies a plurality of facilities corresponding to the transition spot.

Further, in this case, the facility management unit 34 may specify more facilities as the spot, at which the spare time is long, in the movement route. Otherwise, the facility management unit 34 may specify the facility for only a spot, at which the spare time that is equal to or longer than the threshold is generated, in the movement route. In generalization, it is possible to understand that the facility is specified according to a length of the spare time at the spot in the movement route.

In addition, the facility management unit 34 may specify a plurality of facilities which satisfy a usage condition designated by the user. As the usage condition, a time slot, during which a facility is used, is taken into consideration. For example, the facility management unit 34 may specify a plurality of facilities in which it is possible to secure the target prior work time designated by the user. In this case, for each facility, the facility management unit 34 first acquires the first movement time from the nearest station to the facility, and acquires the second movement time from the facility to the destination place. Here, the first movement time and the second movement time may be acquired by performing presetting, or may be acquired by inputting the nearest station, the destination place, and the locational information of the facility to the map application. Subsequently, for each facility, the facility management unit 34 calculates a facility arrival time by adding the first movement time to the nearest station arrival time, and calculates a facility departure time by subtracting the second movement time from the destination place arrival time. Subsequently, the facility management unit 34 specifies a plurality of facilities whose reservations are not made in the prior work time from the facility arrival time to the facility departure time.

Further, the facility management unit 34 outputs pieces of information of the plurality of facilities, which are specified as above, to the screen generation unit 36. In the present exemplary embodiment, the facility management unit 34 is provided as an example of a facility specification unit which specifies a facility to be visited using the moving body.

In addition, in a case where the reception unit 31 receives the facility selection information from the mobile terminal 10, the facility management unit 34 acquires address information of the facility server 60, which makes a reservation for a facility shown in the facility selection information, from the facility information storage unit 35. Further, the facility management unit 34 reports the address information to the transmission unit 37, and instructs to transmit the facility reservation request to the facility server 60. In the present exemplary embodiment, the facility management unit 34 is provided as an example of the facility specification unit which specifies one facility selected from the plurality of facilities.

For each facility, the facility information storage unit stores facility information including locational information of the facility and the address information of the facility server 60 which is accessed in a case where the reservation for the facility is made. The facility information will be described in detail later.

The screen generation unit 36 generates a screen which is displayed on the mobile terminal 10, and instructs the transmission unit 37 to transmit the screen to the mobile terminal 10. Here, as the screen, a suggestion screen is provided which includes information of the moving body specified by the moving body management unit 32 and the pieces of information of the plurality of facilities specified by the facility management unit 34. The suggestion screen may be one screen which includes the information of the moving body and the pieces of information of the plurality of facilities. In this case, the one screen corresponds to, for example, one of the reservation request screen 110 of FIG. 3A and the reservation request screen 120 of FIG. 3B. Otherwise, the suggestion screen may be two screens which respectively include the information of the moving body and the information of the plurality of facilities. In this case, the two screens correspond to, for example, the schedule screen 130 of FIG. 6 and the facility selection screen 150 of FIG. 7.

In addition, in a case where the facility management unit 34 specifies a plurality of facilities whose reservations are not made in the prior work time, the screen generation unit 36 may generate the facility selection screen 150 in which the plurality of facilities are arranged in order that the prior work time is long. Otherwise, the screen generation unit 36 may generate the facility selection screen 150 in which the plurality of facilities are arranged in order that the prior work time is close to the target prior work time. In that sense, the screen generation unit 36 is an example of the facility specification unit which suggests the plurality of facilities according to the stay time in each facility after the moving body, which secures the predetermined stay time in any of the facilities, is specified.

Further, the screen generation unit 36 may generate the facility selection screen 150 in which the plurality of facilities are arranged in order that a sum of the first movement time and the second movement time is short. Also, although the arrangement is equivalent to the arrangement in order that the prior work time is long between the candidates of the facility whose spare time from the nearest station arrival time to the destination place arrival time, the arrangement is not necessarily equivalent the arrangement in order that the prior work time is long between the candidates of the facility whose spare time from the nearest station arrival time to the destination place arrival time is different.

Further, in addition, the facility selection screen 150 may be generated in which the plurality of facilities are arranged in order of the movement time for each type of the moving body, such as the walk or the taxi.

The transmission unit 37 receives a screen generated by the screen generation unit 36, and transmits the screen to the mobile terminal 10.

In addition, the transmission unit 37 accesses the facility server 60 using the address information reported from the facility management unit 34, and transmits the facility reservation request to the facility server 60.

Further, the transmission unit 37 accesses the moving body server 40 using the address information reported from the moving body management unit 32, and transmits the moving body reservation request to the moving body server 40.

In the present exemplary embodiment, the transmission unit 37 is provided as an example of a requesting unit which makes a request for the reservation for the facility or as an example of a processing unit which performs processing of making the reservation for the moving body in a case where the request for the reservation for the facility is accepted.

Here, the moving body information stored in the moving body information storage unit 33 will be described in detail.

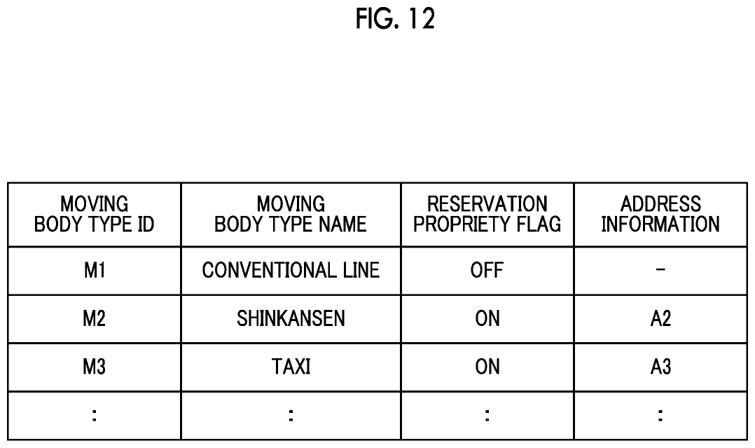

FIG. 12 is a diagram illustrating a detailed example of the moving body information. As being illustrated in the drawing, the moving body information is acquired by associating a moving body type ID with a moving body type name, a reservation propriety flag, and the address information.

The moving body type ID is identification information for identifying the type of the moving body. The moving body type name is a name of the type of the moving body identified by a relevant moving body type ID.

The reservation propriety flag is a flag which shows whether or not the moving body of the type identified by the relevant moving body type ID is a type which is qualitatively available to be reserved. For example, since it is possible to make a reservation for a designated seat of the Shinkansen and it is possible to make a reservation for allocation of the taxi, all the reservation propriety flags become “ON” which shows that it is possible to make the reservation. In contrast, in a case of not a limited express, it is not possible to make a reservation for a designated seat of the conventional line, and thus the reservation propriety flag becomes “OFF” which shows that it is not possible to make the reservation.

The address information is information which shows the address of the moving body server 40 which makes the reservation for the moving body in a case where the moving body of the type identified by the relevant moving body type ID is the type which is qualitatively available to be reserved. For example, it is shown that the moving body server 40 of an address “A2” makes a reservation for a designated seat of the Shinkansen and the moving body server 40 of an address “A3” makes a reservation for arrangement of the taxi. Also, in the case of not the limited express, it is not possible to make the reservation for the designated seat of the conventional line, and thus the address information is not shown.

In addition, the facility information stored in the facility information storage unit 35 will be described in detail.

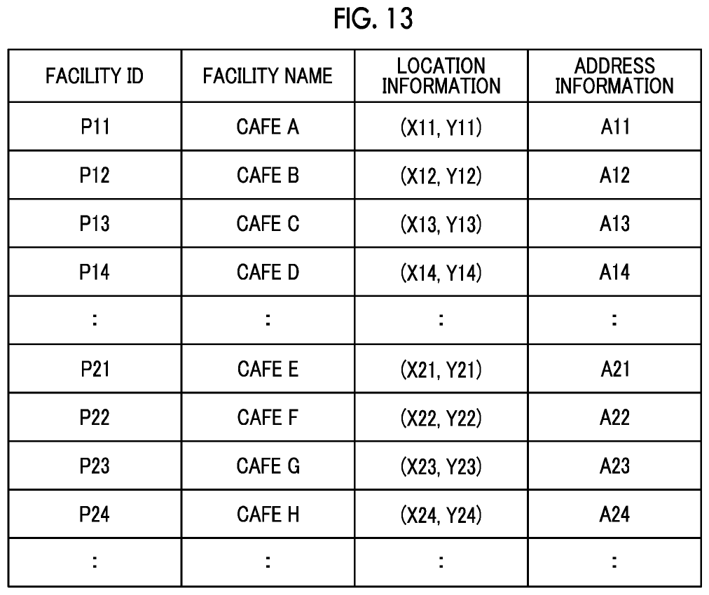

FIG. 13 is a diagram illustrating a detailed example of the facility information. As being illustrated in the drawing, the facility information is acquired by associating a facility ID with a facility name, the locational information, and the address information.

The facility ID is identification information for identifying the facility. The facility name is a name of the facility identified by a relevant facility ID.

The locational information is information which shows a location of the facility identified by the relevant facility ID. Here, although the locational information is shown using latitude and longitude, the locational information may be shown using an address or the like.

The address information is information which shows the address of the facility server 60 that makes the reservation for the facility identified by the relevant facility ID. For example, it is shown that the facility server 60 of an address “A11” makes a reservation for the cafe A and the facility server 60 of an address “A21” makes a reservation for the cafe E.

Operation of Reservation Server

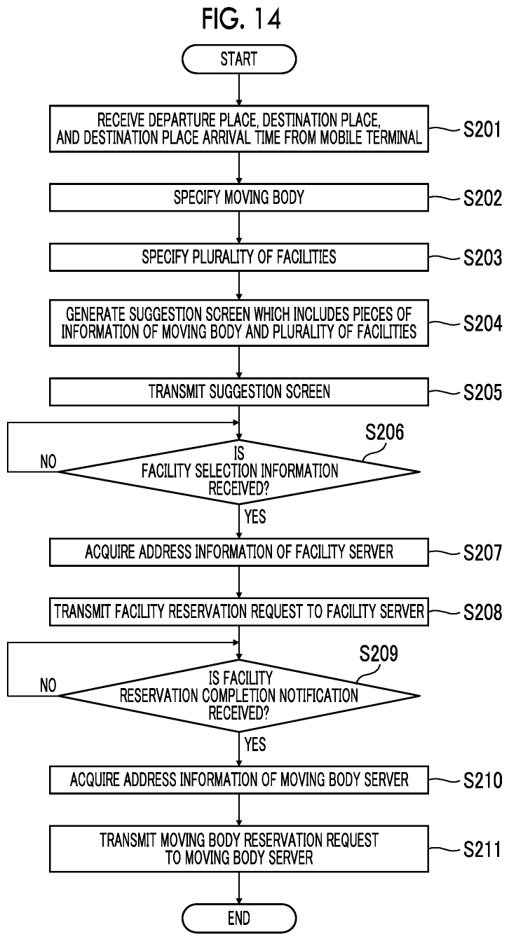

FIG. 14 is a flowchart illustrating an operational example of the reservation server 20.

As illustrated in FIG. 14, in the reservation server 20, first, the reception unit 31 receives the pieces of information of the departure place, the destination place, and the destination place arrival time from the mobile terminal 10 (step S201).

In this case, the moving body management unit 32 specifies the moving body based on the pieces of information of the departure place, the destination place, and the destination place arrival time, which are received in step S201 (step S202). Specifically, in addition to the type of the moving body, the movement time, which shows time of departing from the departure place and time of arriving at the destination place, and the movement route, which shows the movement through the certain place from the departure place to the destination place, are specified.

Subsequently, the facility management unit 34 specifies the plurality of facilities of the spot in the movement route specified in step S202 (step S203). In this case, the facility management unit 34 may specify the plurality of facilities in the geographical range, which is predetermined from the spot in the movement route, or in the time range by collating, for example, locational information of the spot in the movement route with locational information of each of the facilities stored in the facility information storage unit 35. In addition, the facility management unit 34 may specify the plurality of facilities which are available to be reserved at that time point by performing an inquiry using, for example, the address information of each of the facilities stored in the facility information storage unit 35.

Subsequently, the screen generation unit 36 generates the suggestion screen which includes the information of the moving body specified in step S202 and the information of the plurality of facilities specified in step S203 (step S204). Here, the suggestion screen may be one screen which includes both the information of the moving body and the information of the plurality of facilities. In this case, the one screen corresponds to, for example, one of the reservation request screen 110 of FIG. 3A and the reservation request screen 120 of FIG. 3B. Also, since the movement routes are different from each other in FIGS. 3A and 3B, the processes in step S203 and step S204 are executed a plurality of times. FIG. 3A may be considered to illustrate the suggestion screen which includes the movement route specified through one execution and the plurality of facilities, and FIG. 3B may be considered to illustrate the suggestion screen which includes the movement route specified through another one execution and the plurality of facilities. In addition, the suggestion screen may be two screens which respectively include the information of the moving body and the information of the plurality of facilities. In this case, the two screens correspond to, for example, the schedule screen 130 of FIG. 6 and the facility selection screen 150 of FIG. 7.

Thereafter, the transmission unit 37 transmits the suggestion screen generated in step S204 to the mobile terminal 10 (step S205). Therefore, the suggestion screen is displayed on the mobile terminal 10.

In response to the suggestion screen, the mobile terminal 10 transmits the facility selection information which shows the selected facility in a case where the user selects a desired facility from the plurality of facilities included in the suggestion screen. Accordingly, in the reservation server 20, the reception unit 31 determines whether or not the facility selection information is received from the mobile terminal 10 (step S206). As a result, in a case where it is not determined that the facility selection information is received, the reception unit 31 repeats a process in step S206. In contrast, in a case where it is determined that the facility selection information is received, the facility management unit 34 acquires the address information of the facility server 60 which makes the reservation for the facility shown in the facility selection information received in step S206 (step S207). Here, the facility management unit 34 may acquire the address information corresponding to the facility shown in the facility selection information from the facility information stored in the facility information storage unit 35. Further, the facility management unit 34 reports the address information to the transmission unit 37, and instructs to transmit the facility reservation request.

Thereafter, the transmission unit 37 transmits the facility reservation request to the facility server 60 corresponding to the address information acquired in step S207 (step S208).

In a case where the facility server 60 completes the reservation for the facility in response thereto, the facility server 60 replies with the facility reservation completion notification which shows the gist of the completion. Accordingly, in the reservation server 20, the reception unit determines whether or not the facility reservation completion notification is received from the facility server (step S209). As a result, in a case where it is not determined that the facility reservation completion notification is received, the reception unit 31 repeats the process in step S209. In contrast, in a case where it is determined that the facility reservation completion notification is received, the moving body management unit 32 acquires the address information of the moving body server 40 which makes the reservation for the moving body specified in step S202 (step S210). Here, the moving body management unit 32 may acquire the address information corresponding to the moving body specified in step S202 from the moving body information stored in the moving body information storage unit 33. Further, the moving body management unit 32 reports the address information to the transmission unit 37, and instructs to transmit the moving body reservation request.

Thereafter, the transmission unit 37 transmits the moving body reservation request to the moving body server 40 of the address information acquired in step S210 (step S211).

Subsequently, for step S203 and step S204 of FIG. 14, an operation, which is performed in a case where it is presupposed that the prior work is performed before the visit to the destination place, will be described. Also, in this case, prior to the operation, the reception unit 31 receives the nearest station and the target prior work time in step S201.

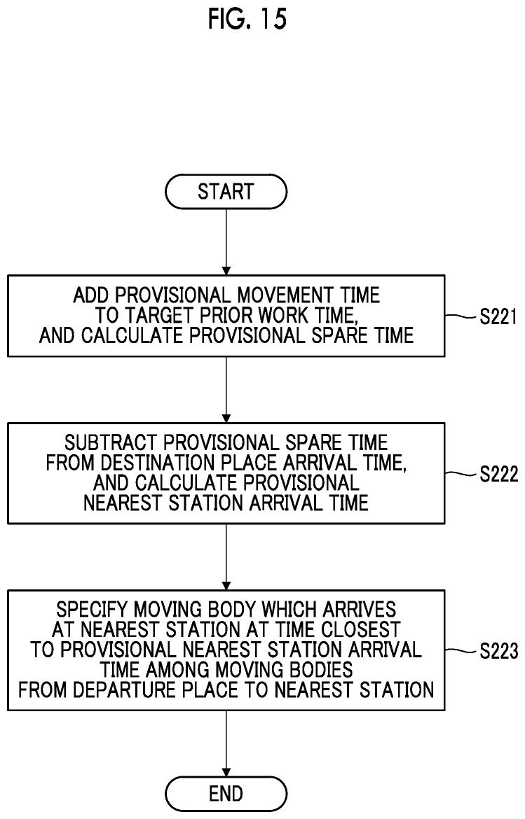

FIG. 15 is a flowchart illustrating an operational example of step S202 in a case where the prior work is performed before the visit to the destination place. That is, the operational example is an operational example for specifying the moving body such that the target prior work time is secured.

As illustrated in FIG. 15, the moving body management unit 32 first adds the provisional movement time to the target prior work time received in step S201, and calculates the provisional spare time (step S221). Here, the provisional movement time is time which is provisionally set as the sum of the movement time from the nearest station to the facility and the movement time from the facility to the destination place, and may be set to, for example, 20 minutes.

Subsequently, the moving body management unit 32 subtracts the provisional spare time calculated in step S221 from the destination place arrival time received in step S201, and calculates the provisional nearest station arrival time (step S222).

Thereafter, the moving body management unit 32 specifies a moving body, which arrives at the nearest station at a time closest to the provisional nearest station arrival time calculated in step S222, among the moving bodies from the departure place to the nearest station which are received in step S201 (step S223). At this time, the nearest station arrival time, in which the specified moving body actually arrives at the nearest station, is specified, and the provisional nearest station arrival time is replaced with the specified nearest station arrival time.

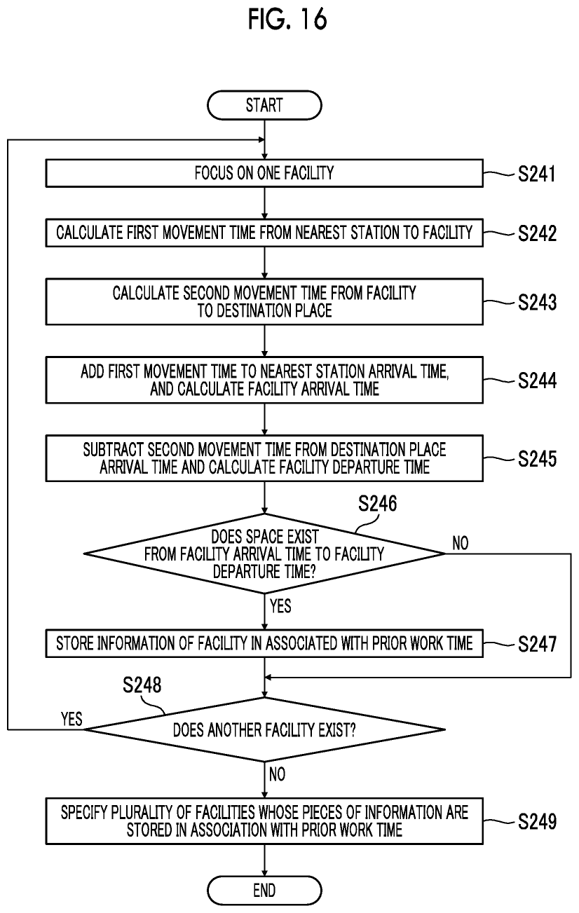

FIG. 16 is a flowchart illustrating an operational example in step S203 in a case where the prior work is performed before the visit to the destination place. That is, the operational example is an operational example for specifying the plurality of facilities in which it is possible to secure the target prior work time.

As illustrated in FIG. 16, the facility management unit 34 first focuses on one facility (step S241). Also, the facility focused on here may be already narrowed by, for example, a condition in which the facility exists in geographical range, which is predetermined from the nearest station, or the time range.

Subsequently, the facility management unit 34 calculates the first movement time from the nearest station received in step S201 to the facility focused on in step S241 (step S242). Further, the second movement time from the facility focused in step S241 to the destination place received in step S201 is calculated (step S243). Here, the first movement time and the second movement time may be calculated using the locational information of each of the facilities included in the facility information stored in the facility information storage unit 35 and map information which is not illustrated in the drawing.

Subsequently, the facility management unit 34 adds the first movement time calculated in step S242 to the nearest station arrival time specified in step S223, and calculates the facility arrival time (step S244). Further, the second movement time calculated in step S243 is subtracted from the destination place arrival time received in step S201, and the facility departure time is calculated (step S245).

In the state, the facility management unit 34 determines whether or not there is a space in the facility from the facility arrival time calculated in step S244 to the facility departure time calculated in step S245 (step S246). As a result, in a case where it is determined that there is the space in the facility from the facility arrival time to the facility departure time, the facility management unit 34 stores information of the facility in associated with the prior work time acquired by subtracting the facility arrival time from the facility departure time (step S247), and causes the process to proceed to step S248. In contrast, in a case where it is not determined that there is the space in the facility from the facility arrival time to the facility departure time, the facility management unit 34 causes the process to proceed to step S248 without change.

Thereafter, the facility management unit 34 determines whether or not there is another facility which is not focused (step S248). Further, in a case where it is determined that there is another facility which is not focused, the facility management unit 34 causes the process to return to step S241. In addition, in a case where it is not determined that there is another facility which is not focused, the facility management unit 34 specifies the plurality of facilities, whose pieces of information are stored in association with the prior work time in step S247 (step S249).

Further, here, the facility management unit 34 also outputs the prior work time, which is associated with each of the facilities, together with the specified pieces of information of the plurality of facilities, to the screen generation unit 36. Therefore, the screen generation unit 36 generates, for example, the suggestion screen in which the pieces of information of the plurality of facilities are arranged according to a length of the prior work time.

### Modified Example of Present Exemplary Embodiment

In the above, although the reservation server 20 makes the reservation for the moving body in a case where the request for the reservation for the facility is accepted and does not make the reservation for the moving body until the request for the reservation for the facility is accepted, the modified example is not limited thereto. The reservation server 20 may restrict the reservation for the moving body until the request for the reservation for the facility is accepted. Here, restriction of the reservation for the moving body includes restriction according to a cancellation policy. The cancellation policy is an example of a policy in a case where the reservation for the moving body is cancelled. For example, for a moving body or a period in which a cancellation fee is not generated [symbol] a reservation may be made for the moving body even before the reservation for the facility is accepted. This is an example in which the reservation is made for the moving body only in a case where the cancellation charge is not generated in a case where the reservation for the moving body is cancelled. In addition for a moving body or a period in which a cancellation fee is generated [symbol] , a reservation is not made for the moving body before the reservation for the facility is accepted. This is an example in which the reservation is not made for the moving body in a case where the cancellation charge is generated in the case where the reservation for the moving body is cancelled.

For realization, for example, a cancellation fee generation flag may be provided in the moving body information stored in the moving body information storage unit 33. The cancellation fee generation flag is, for example, a flag which shows whether or not the cancellation fee is generated in a case where the reservation for the moving body of a type, which is identified by a relevant moving body type ID, is cancelled. The cancellation fee generation flag may show, for example, generation of the cancellation fee as “ON” and non-generation of the cancellation fee as “OFF”. Further, in order to manage a period during which the cancellation fee is generated, a configuration may be applied in which it is possible to change the cancellation fee generation flag according to a moment.

In addition, in the flowchart of FIG. 14, for example, first, a step in which the reservation for the moving body, whose cancellation fee is not generated, may be inserted between step S206 and step S207. Specifically, a step in which the moving body management unit 32 acquires the address information of the moving body server 40, which makes the reservation for the moving body whose cancellation fee generation flag is “OFF”, from the moving body information stored in the moving body information storage unit 33, and a step in which the transmission unit 37 transmits the moving body reservation request to the moving body server 40 of the address information may be inserted. Subsequently, a change may be performed such that step S210 and step S211 are performed for only the moving body in which the cancellation fee is generated. Specifically, step S210 may be changed such that the moving body management unit 32 acquires the address information of the moving body server 40 which makes the reservation for the moving body whose cancellation fee generation flag is “ON”.

In addition, although the reservation server 20 specifies the facility after specifying the moving body in the above, the exemplary embodiment is not limited thereto. The reservation server 20 may specify the moving body after specifying the facility. In this case, for example, the reservation server 20 may specify the moving body to be used for the movement from the departure place to the facility and the moving body to be used for the movement from the facility to the destination place after receiving the reservation completion notification which shows completion of the reservation for the facility to be used.

Further, although the moving body server 40 and the facility server 60 are provided to be separated from the reservation server 20 in the above, the exemplary embodiment is not limited thereto. The reservation server 20 may have a function of the moving body server 40 or a function of the facility server 60. In a case where the reservation server has the function of the moving body server 40, the reservation server 20 may specify and make a reservation for the moving body by, for example, calling a reservation API for each moving body. In addition, in a case where the reservation server 20 has the function of the facility server 60, the reservation server 20 may specify a plurality of facilities, receive the facility selection information, transmit the facility reservation request, and receive the reservation completion notification by, for example, calling a reservation API for the facility.

Program

A process performed by the reservation server 20 in the present exemplary embodiment is prepared as, for example, a program such as application software.

That is, a first program which realizes the present exemplary embodiment is understood as a program causing a computer to realize a function of specifying a moving body to be used, a function of specifying a facility to be visited using the moving body, a function of making a request for a reservation for the facility, and a function of performing processing of making a reservation for the moving body in a case where the request for the reservation for the facility is accepted.

In addition, a second program which realizes the present exemplary embodiment is understood as a program causing a computer to realize a function of specifying a moving body to be used, a function of specifying a facility to be visited using the moving body, a function of making a request for a reservation for the moving body, and a function of performing processing of making a reservation for the facility in a case where the request for the reservation for the moving body is accepted.

Also, it is possible to provide a program which realizes the present exemplary embodiment by a communication unit, and it is possible to provide the program by storing in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A reservation processing apparatus comprising:
a moving body specification unit that specifies a moving body;
a facility specification unit that specifies a facility to be visited using the moving body;
a requesting unit that makes a request for a reservation for the facility; and
a processing unit that performs processing of making a reservation for the moving body in a case where the request for the reservation for the facility is accepted.

2. The reservation processing apparatus according to claim 1,
wherein the moving body specification unit specifies a plurality of movement methods including usage of the moving body in order to move from a departure place to a destination place, and
wherein the facility specification unit specifies the facility corresponding to a transition spot between two movement methods among the plurality of movement methods.

3. The reservation processing apparatus according to claim 2,
wherein the facility specification unit suggests a plurality of facilities corresponding to the transition spot, and specifies one facility selected from the plurality of facilities.

4. The reservation processing apparatus according to claim 3,
wherein the facility specification unit suggests the plurality of facilities in a geographical range, which is predetermined from the transition spot, or in a time range.

5. The reservation processing apparatus according to claim 3,
wherein the facility specification unit suggests the plurality of facilities in an aspect according to a length of spare time at the transition spot.

6. The reservation processing apparatus according to claim 5,
wherein the facility specification unit suggests more facilities as the plurality of facilities as the spare time at the transition spot increases.

7. The reservation processing apparatus according to claim 5,
wherein the facility specification unit suggests the plurality of facilities in a case where the spare time at the transition spot is equal to or longer than a threshold.

8. The reservation processing apparatus according to claim 1,
wherein the processing unit performs processing of restricting the reservation for the moving body until the request for the reservation for the facility is accepted.

9. The reservation processing apparatus according to claim 8,
wherein the processing unit performs the processing of restricting the reservation according to a policy in a case where the reservation for the moving body is cancelled.

10. The reservation processing apparatus according to claim 9,
wherein, as the processing of restricting the reservation, the processing unit performs processing of making the reservation for the moving body only in a case where the reservation for the moving body is cancelled and a cancellation charge is not generated.

11. The reservation processing apparatus according to claim 9,
wherein, as the processing of restricting the reservation, the processing unit performs processing of not making the reservation for the moving body in a case where the reservation for the moving body is cancelled and a cancellation charge is generated.

12. The reservation processing apparatus according to claim 1,
wherein the moving body specification unit specifies the moving body which secures predetermined stay time in any of the facilities.

13. The reservation processing apparatus according to claim 12,
wherein the facility specification unit suggests a plurality of facilities according to the stay time in each facility after the moving body is specified by the moving body specification unit, and specifies one facility selected from the plurality of facilities.

14. A reservation processing apparatus comprising:
a moving body specification unit that specifies a moving body;
a facility specification unit that specifies a facility to be visited using the moving body;
a requesting unit that makes a request for a reservation for the moving body; and
a processing unit that performs processing of making a reservation for the facility in a case where the request for the reservation for the moving body is accepted.

15. A non-transitory computer readable medium storing a program causing a computer to realize:
a function of specifying a moving body;
a function of specifying a facility to be visited using the moving body;
a function of making a request for a reservation for the facility; and
a function of performing processing of making a reservation for the moving body in a case where the request for the reservation for the facility is accepted.

16. A non-transitory computer readable medium storing a program causing a computer to realize:
a function of specifying a moving body;
a function of specifying a facility to be visited using the moving body;
a function of making a request for a reservation for the moving body; and
a function of performing processing of making a reservation for the facility in a case where the request for the reservation for the moving body is accepted.
